(19) United States
(12) Patent Application Publication
(10) Pub. No.: US 2021/0170777 A1
(43) Pub. Date: Jun. 10, 2021

(54) AN IMAGE-RECEPTIVE COATING FOR HIGH-SPEED PRINTING APPLICATIONS

(71) Applicant: INNOVATION TECHNOLOGY COATINGS LTD, Harlow, Essex (GB)

(72) Inventor: Thomas LEU, Lohn (CH)

(73) Assignee: Innovation Technology Coatings Ltd, Harlow, Essex (GB)

(21) Appl. No.: 17/045,709

(22) PCT Filed: Mar. 27, 2019
(86) PCT No.: PCT/GB2019/000053

§ 371 Date: Oct. 6, 2020

(30) Foreign Application Priority Data
Apr. 4, 2018 (GB) 1805493.2

(51) Int. Cl. B41M 5/52; B41J 2/02; C09D 11/322; B41M 7/00

(52) U.S. Cl. CPC B41M 5/5254; B41J 2/02; B41M 5/5281; B41M 7/009; B41M 5/5272; C09D 11/322

(57) ABSTRACT

A method of preparing a washable durable image on a polyester film from water-based inks using an ink-jet printer, wherein the method comprises providing a substrate having a coating comprising approximately 4% by weight of polyvinyl alcohol as a binder, approximately 30% by weight of Polyethylene powder as an ink absorbing pigment. An image is printed on the coated substrate and is then thermally fused to the coated substrate.

The present invention relates to an image-receptive coating for high speed printing applications.

### BACKGROUND TO THE INVENTION

Inkjet printable substrates for high-speed printers use heating devices to convert prints into durable images.

There are many potential applications that use high-speed printing in such a way including, without limitation, printing of labels, tags and packaging using base substrates such as for example without limitation, paper, films, textiles or non-woven materials with or without an adhesive layer.

High-speed industrial inkjet printing demands high durable prints, which leads to the use of Ultra Violet (UV) printers in the majority of cases.

UV inks do not contain solvents or water and so do not require any drying time in the printing process. Rather, UV inks become crosslinked by use of strong UV-light in a UV dryer (UV hardening unit). As a result of the complex hardware required UV-printing systems are generally expensive.

Moreover, the main chemicals within the ink are monomers and photo-initiators which have a tendency to migrate. This is a particular problem in the packaging industry as the chemicals have a tendency to migrate into the packaging thereby contaminating the goods inside.

For at least the reasons above, there is a main focus for many high-speed printing industries to replace UV-printing systems with printing systems that use water-based printing ink.

Water-based printing systems require substrates of high absorbing capability for absorbing the water or solvent content of the ink, or require a forced drying process by heat and air.

Warm air tunnels or infrared heaters have been used for the purpose of drying.

So called Latex printers use heating plates on the backside of the printed substrate to speed up the evaporation of the water or solvent content of the ink.

However, neither of these are practical high speed printing units as there is not sufficient time to evaporate the water or solvent content.

A further problem associated with the high speed printing industry is that the printed image has no protection if no varnish or protective film laminate is applied. As a result the image is extremely sensitive to mechanical impact for example scratching or rubbing, and to water or chemicals such as solvents and the like.

Furthermore, fading or dirt-contamination induced by UV light and ozone is a well-known problem.

The present invention seeks to alleviate the aforementioned problems with current high-speed printing systems by combining inkjet printing technology with heating devices to cause the coating of a base substrate to interact with any type of inkjet-ink (particularly water-based ink) in order to fix the ink and encapsulate the dyes to build a durable image.

The research in this area is extensive and, as yet the applicant is not aware of any formulations that meet the requirements of high speed ink-jet printing of chemical/GHS labels, especially ones that meet the criteria for sea water resistance under British Standard BS5609.

EP1101627 (Ilford) discloses a printing method comprising printing ink on a substrate such that a film is formed and then applying heat and pressure to fuse the polymer. The formulas are based on Polyvinyl alcohol (PVOH) as the main binder and Polyethylene-powder (PE) as the ink absorbing pigment which is meltable/sealable. The Applicant has found that the system disclosed performed well in terms of printability resolution. However the PVOH and PE are incompatible while melting. The molten blend stayed milky in colour and did not turn transparent which is a key requisite to develop a printed image with full colour brilliance. Moreover, dipping the sealed samples in water for a period of time caused the sealed layer to lose its initial scratch/rub resistance and its adhesion to the substrate. This effect increased with an increase in water temperature.

CA2372770 (Lanquart) discloses a printable substrate that has a one print fixing layer and a film forming organic pigment and filmable coating containing a binding agent. The Applicant has found that the formula disclosed does not provide sufficient resistant to meet the requirements of today's label industry and, more importantly, is not compatible with pigment-based inkjet inks. The system only works on dye-based inks due to the pore size of the coating. Pigments do not become absorbed and fixed by the coating while sealing, rather the pigments remain on top of the coating, un-fixed and without protection.

Other prior art, such as U.S. Pat. No. 6,450,633 (Neenah) focus on textile transfer printing and utilise high melt range Polyamide particles due to their resistance against acidic and alkaline chemicals to provide a high degree of washability.

Lowering the sealing temperature, which is a requisite for high-speed printing with fast ink absorption, generally reduces the acidic and alkaline resistance. This would result in a lower degree of washability which would teach against the purpose of the invention disclosed, which is focused on textile transfer printing.

On the other hand, a criteria of the present invention is to provide a formulation that has a low sealing temperature, due mainly to significantly reduced dwell time due to its application in high speed inkjet printing process, whilst retaining a high degree of chemical resistance.

### DETAILED DESCRIPTION OF PREFERRED EMBODIMENTS

The focus on the present invention is to provide a meltable, porous coating which is printable using inkjet inks in a high-speed printing system where the dwell time available to encapsulate the ink into the coating is extremely limited.

The applicant has undertaken extensive research, development and experimentation to establish the optimum composition of the coating that meets the criteria of printability and protection, after being formed in a high speed printing environment where dwell time is extremely limited.

The following examples of formula will serve to illustrate the invention and provide formulas that increase the performance of sealable coatings to make them applicable in high-speed printing systems.

Formula 1

| | |
|---|---|
| Ethanol (95% solution) | 6.40 g |
| demin H₂O | 3.20 g |
| Elvamide 8061¹ | 1.70 g |
| Pre-dissolve at 60° C., then add: | |
| Ethanol (H₂-75:25) | 8.50 g |
| Isopropanol | 1.20 g |
| Orgasol 3501 EXD NAT.1² | 4.00 g |

¹Polyamide resin/textile adhesive made by Dupont ®
²Polyamide powder made by Arkema ®

This composition consists of a Polyamide resin as a binder and Polyamide powder as an ink absorbing pigment, which is heat-sealable at or over 140° C.

The formulation was coated onto a sheet of transparent polyester film. An image was printed with water-based pigmented inks using a photo printer and the printed coating was sealed using an image transfer heat press at 160° C. for 10 seconds. While heating/pressing, the coating was protected by using a sheet of one-sided siliconized polyester film. Tests of the composition found the sealed layer to become transparent. The sealed layer also showed a high degree of water resistance and chemical resistance.

The layer showed strong resistance to acidic or alkaline exposure thereby allowing the printed product to be washable at common wash temperatures of 40° C. to 60° C.

The coating would therefore have good applicability in the textile label or carpet tag market for example. The coating would however may not be applicable for the traditional label market that use bi-axially oriented polypropylene films (BOPP) as a substrate as such films would melt or shrink at the melting range of the composition and the pressure sensitive adhesive would be destroyed.

The applicant has identified that the following formula overcomes these limitations.

Formula 2

| | |
|---|---|
| demin H₂O | 52.35 g |
| Nolax S35.3031 (37.5%)³ | 13.42 g |
| Poval R-1130 (9%)⁴ | 4.03 g |
| Coathylene HX-1681⁵ | 30.20 g |

³Textile adhesive made by Nolax AG
⁴SI-modified polyvinyl alcohol
⁵Polyethylene powder made by Axalta Coating Systems

This composition has a reduced melting range and would therefore be more applicable to the traditional label market. The composition may further include Polyvinyl acetate, Acrylic, Polyurethane or CoPolyester resin as a binder and Polyethylene Powder as the ink absorbing pigment to increase the performance of the formula. Use of Polyethylene as the fusible polymer particles results in lower sealing temperatures which causes an increase in chemical resistance because Polyethyelene is insoluble in most types of organic solvents. This lends the formulation to particular use in production of chemical labels that comply with the Globally Harmonized System (“GHS”).

The formulation was coated onto a sheet of transparent polyester film (96 micron CF 182 manufactured by Polypex®). An image was printed with water-based pigmented inks using a photo printer (Epson Stylus Photo R2400 printer) and the printed coating was sealed using an image transfer heat press at different temperatures between 110° C. and 120° C. for 5 seconds. While heating/pressing, the coating was protected by using a sheet of one-sided siliconized polyester film (36 micron Siliphan S36M manufactured by Siliconature®).

In an alternative experiment, the coating was sealed by passing the printed sheet through an office laminator (Olympia S34040, setting 150MIC). The coated/printed side of the sheet was covered by the same type of one-sided siliconized polyester film to prevent from adhering to the heated rubber rollers.

Tests of this composition have found it to have good sealing properties at temperatures of 110° C. or more. Furthermore, the sealed layer became transparent, and also showed a high degree of water resistance and chemical resistance.

The layer showed strong resistance to acidic or alkaline exposure thereby allowing the printed product to be washable at normal temperatures of 40 to 60° C.

The heating time was found to be just as important as the temperature. Increases in temperature, result in a reduction in the dwell time.

A further important parameter is the applied pressure. In contactless sealing units (for example hot air or infrared radiation units) there is no pressure. The sealing process is defined by the difference in temperature above the melt range of the coating and the dwell time.

In contact sealing units (for example, heat presses and hot roller type laminators) the required temperature and/or dwell time can be significantly reduced by increasing the pressure.

Even sealing temperatures below the melt range of the coating are possible.

Contact sealing can though have undesirable effects such as a lower print resolution caused by pressure induced expansion of the dot sizes of the ink drops, or by changing the adhesive performance of self-adhesive label materials through squeezing of the adhesive layer.

1. A method of preparing a washable durable image on a polyester film from water-based inks using an ink-jet printer, wherein the method comprises:
providing a substrate having a coating comprising:
approximately 4% by weight of polyvinyl alcohol as a binder;
approximately 30% by weight of Polyethylene powder as an ink absorbing pigment;
printing an image on the coated substrate; and
thermally fusing the ink jet printed image to the coated substrate.

2. The method according to claim 1, wherein the image is thermally fused at a temperature of between 100° C. and 120° C. for a dwell time of approximately 5 seconds.

3. The method according to claim 1, wherein the coating further includes polyurethane resin or co-polyester resin as a binder.

4. The method according to claim 3, wherein the coating further includes polyvinyl acetate or acrylic as the binder.
